(19) United States
(12) Patent Application Publication
(10) Pub. No.: US 2010/0084162 A1
(43) Pub. Date: Apr. 8, 2010

(54) ELECTRONIC PACKAGE DEVICE

(76) Inventor: Chung-Jyh LIN, Tainan County (TW)

Correspondence Address: BIRCH STEWART KOLASCH & BIRCH, PO BOX 747, FALLS CHURCH, VA, 22040-0747, US

(21) Appl. No.: 12/570,862

(22) Filed: Sep. 30, 2009

(30) Foreign Application Priority Data
Oct. 3, 2008 (TW) 097138250

(51) Int. Cl. H01B 3/00

(52) U.S. Cl. 174/17 R

(57) ABSTRACT

An electronic package device has an accommodation space being substantially sealed. The electronic package device includes a fluid, an electronic element and a space buffer mechanism. The fluid is located in the accommodation space. The electronic element is also disposed in the accommodation space, and at least a part thereof contacts with the fluid. The space buffer mechanism at least partially contacts with the fluid and provides the displacement or deformation to buffer the volume variation of the fluid.

### CROSS REFERENCE TO RELATED APPLICATIONS

This Non-provisional application claims priority under 35 U.S.C. §119(a) on Patent Application No(s). 097138250 filed in Taiwan, Republic of China on Oct. 3, 2008, the entire contents of which are hereby incorporated by reference.

### BACKGROUND OF THE INVENTION

1. Field of Invention

The present invention relates to a package device and, in particular, to an electronic package device.

2. Related Art

In order to normally execute the electrical and optical functions and provide good performance and lifetime of the small electronic elements, they are usually sealed in a package structure so as to form an electronic package device.

However, the packaged electronic elements may easily generate a lot of heat in operation, which will result in the deformation, malfunction or heat accumulation of the electronic package device. Therefore, it is an important subjective to provide an electronic package device that can overcome the heat dissipation and thermal expansion problems.

### SUMMARY OF THE INVENTION

In view of the foregoing, the present invention is to provide an electronic package device that can bear the thermal expansion and dissipate heat.

To achieve the above, the present invention discloses an electronic package device having a substantially sealed accommodation space. The electronic package device includes a fluid, an electronic element and a space buffer mechanism. The fluid is located in the accommodation space. The electronic element is disposed in the accommodation space, and at least a part of the electronic element contacts with the fluid. The first space buffer mechanism at least partially contacts with the fluid and provides displacement or deformation to buffer the volume variation of the fluid.

In addition, the present invention also discloses an electronic package device including a case, a space buffer mechanism, a fluid and an electronic element. The space buffer mechanism and the case together form a fluid accommodation space, and the space buffer mechanism provides displacement or deformation corresponding to the volume variation of the fluid accommodation space. The fluid is located in the fluid accommodation space. The electronic element is disposed in the fluid accommodation space, and at least a part of the electronic element contacts with the fluid.

In the present invention, the electronic element generates heat, and then the convection of the fluid can speed up the heat dissipation.

In one aspect of the present invention, the accommodation space can be formed by different ways, such as the way of sealing the case or the way of combining the case and the space buffer mechanism. At least one part of the accommodation space is used for accommodating the fluid.

In one embodiment of the present invention, the electronic package device includes a case, which has the accommodation space. At least one space buffer mechanism is disposed in the case or in the accommodation space. In other words, the accommodation space can be divided into two portions, one of which is used for accommodating at least one space buffer mechanism, and the other one of which is used for accommodating the fluid and the electronic element.

In one embodiment of the present invention, the electronic package device includes at least one case, which is combined with the space buffer mechanism to form the accommodation space. Most part of the accommodation space is used for accommodating the fluid and the electronic element. For example, the case has a first portion and a second portion, which are connected with each other, and the space buffer mechanism is connected with the first and second portions. In another embodiment, the electronic package device may include a plurality of cases, and the two ends of the space buffer mechanism are connected with the cases to form the accommodation space. The shapes of the cases may match with each other. For example, one case has an opening, which substantially matches with the size and shape of another case.

No matter the accommodation space is formed by one or more cases, the case and the space buffer mechanism can be separated pieces or an integral piece. In addition, if the case has a first portion and a second portion, the first and second portions can be separated pieces or an integral piece. Otherwise, the first portion of the case and the space buffer mechanism can be separated pieces or an integral piece, or the second portion of the case and the space buffer mechanism can be separated pieces or an integral piece.

The case and the space buffer mechanism can be combined by adhering or embedding. Otherwise, one part of the space buffer mechanism is adhered to the case and another part thereof is embedded to the case. That is, two or more parts of the space buffer mechanism can be separately connected to the case by two or more different ways.

In addition, the electronic element can be disposed on the case, and at least one part of the case can be a circuit board, which is electrically connected with the electronic element.

Regarding to the thermal property, at least one part of the case can be a heat-dissipation body for dissipating the heat of the electronic element. Regarding to the optical property, at least one part of the case can be a transparent body, a heat-dissipation body, a light-scattering body, a light-condensing body, a wavelength-conversion body, or a light-reflection body. Regarding to the material, at least one part of the case can be made of glass, metal, or ceramics. In addition, a surface of the case, which faces toward or is away from the accommodation space, may be disposed with a heat-dissipation body, a light-scattering body, a light-condensing body, a wavelength-conversion body, or a light-reflection body.

The space buffer mechanism can be disposed inside the case. For example, the space buffer mechanism is disposed in the accommodation space formed by simply sealing the case. Otherwise, the space buffer mechanism and the case may together form the accommodation space. Alternatively, the space buffer mechanism may be disposed outside the case and connected with the case to form the accommodation space.

No matter how the accommodation space is formed, the electronic package device may include a plurality of space buffer mechanisms, which are disposed in the accommodation space and/or outside the case. In other words, some of the space buffer mechanisms are disposed inside the case, and the others are disposed outside the case. Alternatively, the space buffer mechanisms may be all disposed inside the case, or they may be all disposed outside the case.

The space buffer mechanism can be a single member such as a flexible member or a member with a buffer space; otherwise, it can be composed of a plurality of members. For example, the space buffer mechanism is an elastic member or a sliding member; otherwise, it may include an elastic member or a sliding member. Alternatively, the space buffer mechanism is an elastic member or a sliding member; otherwise, it may include an elastic member or a sliding member. In addition, the space buffer mechanism is a silica gel film, balloon or piston; otherwise, it may include a silica gel film, balloon or piston. Alternatively, the space buffer mechanism may include a channel and a sliding partition member, which is slidingly disposed in the channel.

In addition, the electronic element is a bare chip or a small-sized electronic element. Regarding to the material, the electronic element can be a semiconductor element, an organic semiconductor element, or an organic electronic element. The electronic element can be fabricated by thin-film manufacturing processes such as PVD, CVD or printing. Regarding to the application field, the electronic element can be an optoelectronic element, a power element, or a processing circuit. The optoelectronic element can be an electronic-optical converting element or an optical-electronic converting element, such as, but not limited to, an LED, an OLED or a solar cell. The power element is, for example but not limited to, a semiconductor power element, a power transistor, or a power LED. The processing circuit is, for example but not limited to, an integrated circuit, a microprocessor, a DSP, or an ASIC. Besides, the electronic element can be a superconductor element.

In addition, the fluid can be doped with a fluorescent transformation material, and it can be gel, liquid, gas or their combinations.

As mentioned above, the electronic package device of the present invention has a space buffer mechanism for providing displacement or deformation to buffer a volume variation of the fluid accommodation space. Thus, the electronic package device can be prevented from being damaged by the internal expansion or constriction thereof. In addition, the fluid disposed inside the electronic package device can facilitate the heat dissipation of the electronic element, so that the electronic package device can have better heat-dissipation efficiency.

### BRIEF DESCRIPTION OF THE DRAWINGS

The invention will become more fully understood from the detailed description and accompanying drawings, which are given for illustration only, and thus are not limitative of the present invention, and wherein:

FIGS. 1A to 7B are schematic diagrams of the element package device according to a preferred embodiment of the present invention.

### DETAILED DESCRIPTION OF THE INVENTION

The present invention will be apparent from the following detailed description, which proceeds with reference to the accompanying drawings, wherein the same references relate to the same elements.

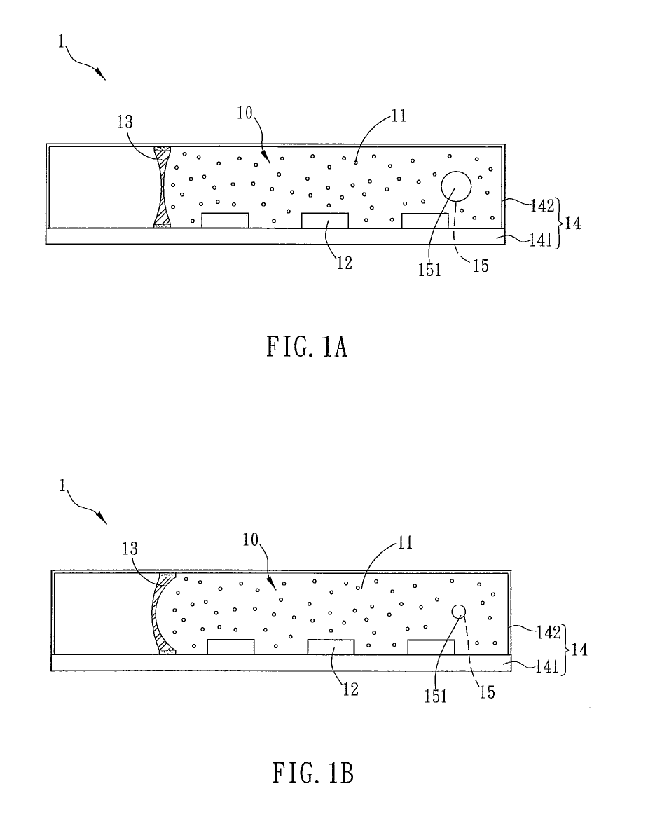

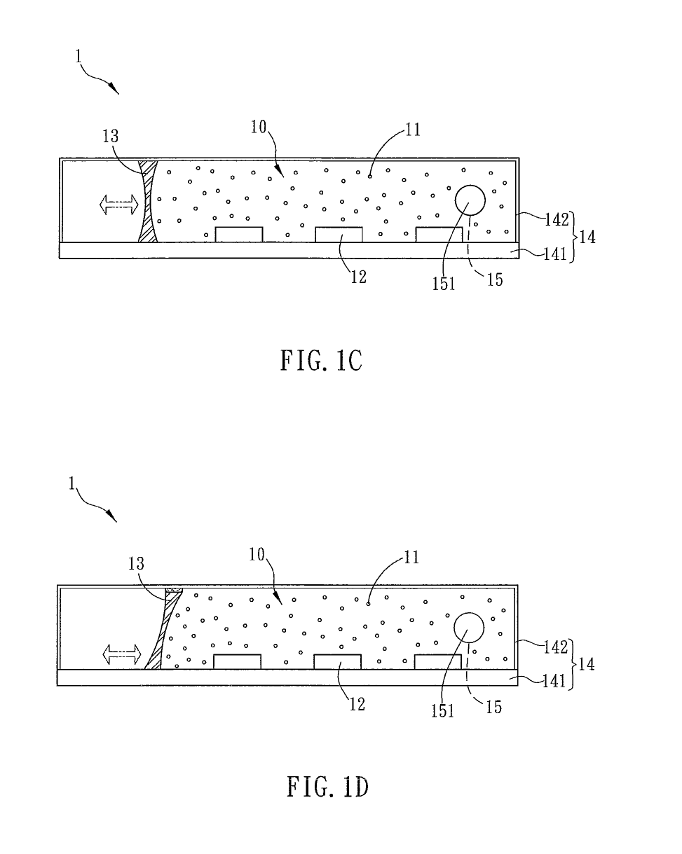

With reference to FIG. 1A, an electronic package device 1 according to a preferred embodiment of the present invention includes a fluid 11, an electronic element 12, a space buffer mechanism 13 and a case 14. The case 14 has a substantially sealed accommodation space 10, and the fluid 11 is located in the accommodation space 10. The electronic element 12 is disposed in the accommodation space 10, and at least a part of the electronic element 12 contacts with the fluid 11. The space buffer mechanism 13 at least partially contacts with the fluid 11 and provides displacement or deformation to buffer the volume variation of the fluid 11.

At least one part of the accommodation space 10 is used for accommodating the fluid 11. In other words, a part of the accommodation space 10 is used as the space buffer mechanism 13, and the other part thereof is used for accommodating the fluid 11 and the electronic element 12. The space buffer mechanism 13 can have the displacement or deformation in accordance with the volume variation of the fluid accommodation space.

The case 14 has a first portion 141 and a second portion 142, which are connected with each other. The first and second portions 141 and 142 can be separated pieces or an integral piece. The space buffer mechanism 13 is connected with the first and second portions 141 and 142, and the case 14 and the space buffer mechanism 13 can be connected by adhering or embedding. In addition, the space buffer mechanism 13 and the case 14 can be separated pieces or an integral piece.

At least one part of the case 14, such as the first portion 141, the second portion 142, a sub-part of the first portion 141, or a sub-part of the second portion 142, is a transparent body, a heat-dissipation body, a light-scattering body, a light-condensing body, a wavelength-conversion body, or a light-reflection body. Regarding to the material, at least one part of the case 14, such as the first portion 141, the second portion 142, a sub-part of the first portion 141, or a sub-part of the second portion 142, can be made of glass, metal, ceramics, or a plastic material.

For example, the first portion 141 is made of glass and is a transparent body, and the second portion 142 is made of metal and is a light-reflection body. Alternatively, a sub-part of the first portion 141 is a light-reflection body, and a sub-part of the second portion 142 is a light-condensing body. The optical properties, thermal properties and materials of the first portion 141, the second portion 142 or the sub-parts thereof can be any of the above described features, so the detailed descriptions thereof will be omitted.

In addition, the electronic package device may further include an optical element (not shown), which is assembled with the case or the space buffer mechanism. For example, the case 14 may be assembled with a light-scattering body, a light-condensing body, a wavelength-conversion body, a light-reflection body, or a fluorescent tape. These assembled elements can be disposed inside or outside the case 14. Furthermore, the case 14 may be assembled with a heat-dissipation body, which can be disposed inside or outside the case 14.

The electronic element 12 is disposed on the first portion 141 of the case 14. The first portion 141 or the sub-part thereof can be a circuit board with circuit layout, so that the electronic element 12 can electrically connect with the circuit layout. The circuit layout of the circuit board may further electrically connect with external electronic elements such as driving circuits, control circuits or power supply circuits, so that the electronic element 12 can be driven, controlled or applied with power by these external electronic elements. In addition, the circuit board can be a common printed circuit board or glass circuit board. Alternatively, the electronic element 12 can be disposed on the second portion 142 of the case 14.

The electronic element 12 can be a bear chip or other small-sized electronic element. Regarding to the material, the electronic element 12 can be a semiconductor element, an organic semiconductor element, or an organic electronic element. The electronic element 12 can be fabricated by thin-film manufacturing processes, such as PVD, CVD or printing. Regarding to the application field, the electronic element can be an optoelectronic element, a power element, or a processing circuit. The optoelectronic element can be an electronic-optical converting element or an optical-electronic converting element such as, but not limited to, an LED, an OLED or a solar cell. The power element is, for example but not limited to, a semiconductor power element, a power transistor, or a power LED. The processing circuit is, for example but not limited to, an integrated circuit, a microprocessor, a DSP, or an ASIC. Besides, the electronic element 12 can be a superconductor element.

The fluid 11 is capable of facilitate the heat dissipation of the electronic element 12. In more details, the fluid 11 can flow to enhance the heat-dissipation efficiency by convection. In addition, the fluid 11 can be doped with an antirust component.

Moreover, the electronic package device 1 further includes another space buffer mechanism 15 disposed in the accommodation space 10. The space buffer mechanism 15 has a buffer space 151, which can be expended or constricted in accordance with the volume variation of the fluid 11. Alternatively, the space buffer mechanism 15 can also be a balloon or a piston.

In the present embodiment, the space buffer mechanisms 13 and 15 are a silica gel film and a balloon, respectively. When the fluid 11 expends as shown in FIG. 1B, the space buffer mechanisms 13 and 15 are deformed. In this case, the center portion of the space buffer mechanism 13 shifts toward the direction away from the fluid 11. In addition, the space buffer mechanism 15 is constricted, so that the buffer space 151 inside the space buffer mechanism 15 is shrunk. Otherwise, when the fluid 11 constricts, the space buffer mechanisms 13 and 15 are also deformed. In this case, the center portion of the space buffer mechanism 13 shifts toward the fluid 11. In addition, the space buffer mechanism 15 is expanded, so that the buffer space 151 inside the space buffer mechanism 15 is expanded. As mentioned above, the space buffer mechanisms 13 and 15 can provide deformations in accordance with the pressure from the fluid 11.

In addition, regarding to the shape, the shape of the space buffer mechanism 13 can be a thin film, a slice, a plate or a block. Regarding to the deformation property, the space buffer mechanism 13 can be a deformable body or a flexible element. Regarding to the material, the space buffer mechanism 13 can be made of silica gel or rubber.

For example, the space buffer mechanism 13 is a silica gel film, and its periphery is connected with the case 14. Thus, the space buffer mechanism 13 can be deformed due to the different pressures at the two sides thereof.

The space buffer mechanism 13 and the case 14 can be connected by adhering, embedding or other fixing manners. Alternatively, a part of the space buffer mechanism 13 can be adhered to the case 14, and the other part thereof can be embedded to the case 14. That is, the space buffer mechanism 13 and the case 14 can be connected by two or more different ways.

In addition, the space buffer mechanism 13 can be a sliding member as shown in FIG. 1C. In this case, the space buffer mechanism 13 is not fixed on the case 14, so that it can move inside the case 14 when the pressure is applied. Alternatively, as shown in FIG. 1D, a part of the space buffer mechanism 13 is fixed on the case 14 and the other part is not, so that the unfixed part can move as the pressure is applied.

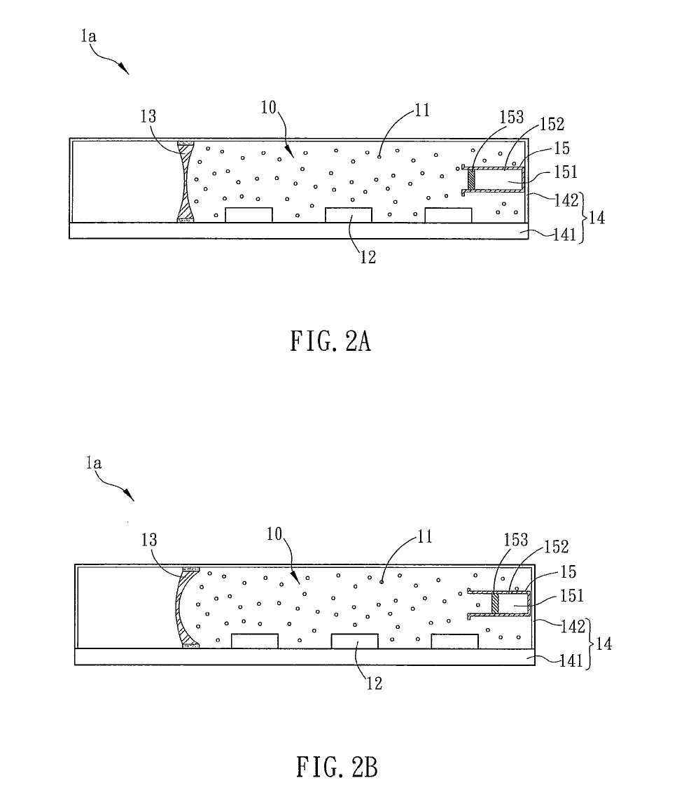

Referring to FIG. 2A, an electronic package device 1a is different from that of FIG. 1A in that the space buffer mechanism 15 has a channel 152 and a sliding partition member 153, which is slidingly disposed in the channel 152.

In this embodiment, when the fluid 11 expends as shown in FIG. 2B, the space buffer mechanism 13 is deformed and the space buffer mechanism 15 is moved. In this case, the center portion of the space buffer mechanism 13 shifts toward the direction away from the fluid 11. Meanwhile, the sliding partition member 153 of the space buffer mechanism 15 moves toward the buffer space 151 along the channel 152, so that the buffer space 151 inside the space buffer mechanism 15 is shrunk. Otherwise, when the fluid 11 constricts, the space buffer mechanism 13 is also deformed and the space buffer mechanism 15 is also moved. In this case, the center portion of the space buffer mechanism 13 shifts toward the fluid 11, and the sliding partition member 153 of the space buffer mechanism 15 moves toward the fluid 11 along the channel 152. Thus, the buffer space 151 inside the space buffer mechanism 15 is expanded.

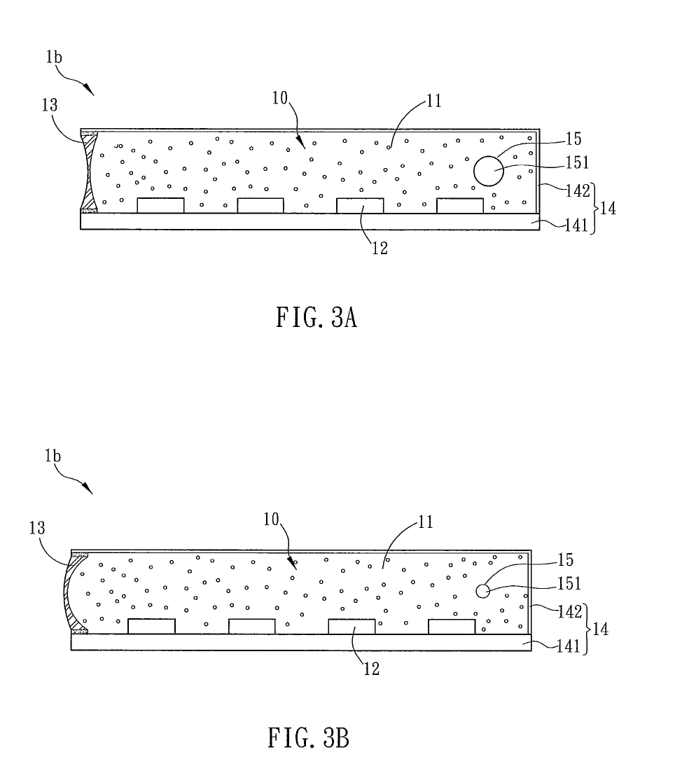

Referring to FIG. 3A, an electronic package device 1b is different from that of FIG. 1A in that the case 14 is combined with the space buffer mechanism 13 to form the accommodation space 10. In this case, the case 14 and the space buffer mechanism 13 construct the entire external part of the electronic package device 1b, and the space buffer mechanism 13 can isolate the sealed accommodation space 10 with an external space.

In this embodiment, when the fluid 11 expends as shown in FIG. 3B, the space buffer mechanism 13 is deformed. In this case, the center portion of the space buffer mechanism 13 shifts toward the external space. Otherwise, when the fluid 11 constricts, the space buffer mechanism 13 is also deformed. In this case, the center portion of the space buffer mechanism 13 shifts toward the fluid 11.

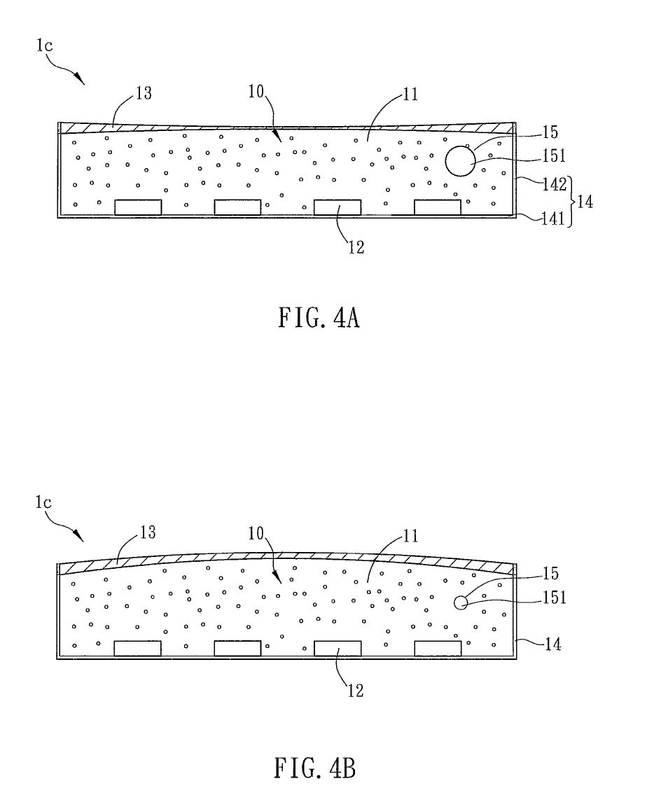

Referring to FIG. 4A, an electronic package device 1c is different from that of FIG. 1A in that the case 14 is combined with the space buffer mechanism 13 to form the accommodation space 10, and the space buffer mechanism 13 is disposed opposite to the case 14. In this case, the electronic element 12 is disposed on the case 14, so the space buffer mechanism 13 is also disposed opposite to the electronic element 12.

In this embodiment, when the fluid 11 expends as shown in FIG. 4B, the space buffer mechanism 13 is deformed. In this case, the center portion of the space buffer mechanism 13 shifts toward the external space. Otherwise, when the fluid 11 constricts, the space buffer mechanism 13 is also deformed. In this case, the center portion of the space buffer mechanism 13 shifts toward the fluid 11.

The electronic package device 1c may be combined with other devices. For example, the case 14 can be installed or fixed on an external product or the ground. In this case, the space buffer mechanism 13 is not limited by the external product, so that it can still have deformation.

In addition, at least one part of the space buffer mechanism 13 can be an optical modulation element such as, for example but not limited to, a light-scattering body, a light-condensing body, a wavelength-conversion body, a light-reflection body, or a fluorescent tape, for adjusting the input and output light.

For example, if the electronic element 12 is an LED, the space buffer mechanism 13 can cooperate with the fluid 11 to adjust the output angle of the light of the electronic element 12 passing through the space buffer mechanism 13. Alternatively, if the electronic element 12 is a solar cell, the space buffer mechanism 13 can cooperate with the fluid 11 to adjust the focus of the input light to the electronic element 12.

Because the structures, functions, connections and manufacturing manners of the elements shown in FIGS. 2A to 4B, such as the case, fluid, electronic element, and space buffer mechanism, are the same as or similar to those described in the previous or following embodiments, the detailed descriptions thereof will be omitted.

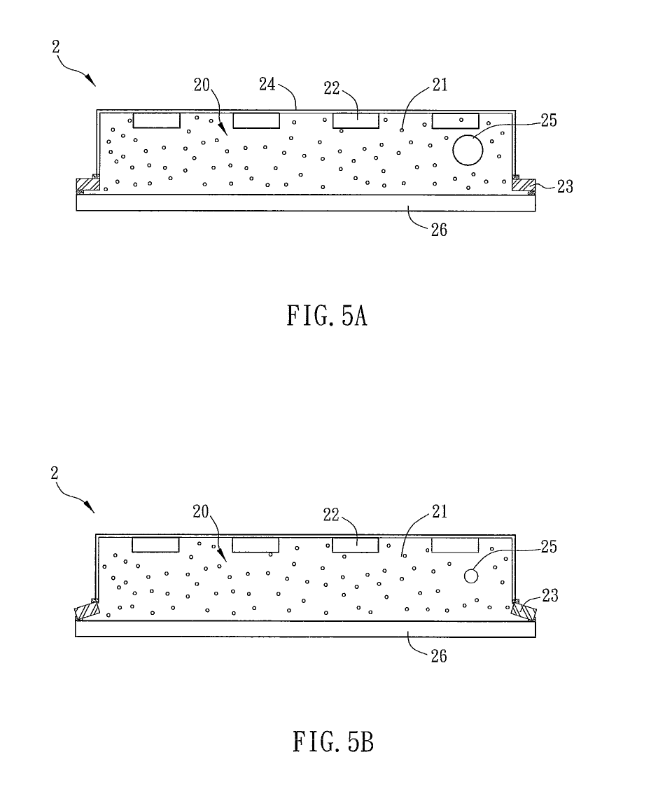

Referring to FIG. 5A, an electronic package device 2 is different from that of FIG. 1A in that the cases 24 and 26 are combined with the space buffer mechanism 23 to form the accommodation space 20. In this case, the two ends of the space buffer mechanism 23 are connected with the cases 24 and 26, respectively, to form the accommodation space 20. The shape of the case 24 is a container, and the case 24 has an opening toward the case 26. The electronic element 22 is disposed on the case 24 and is opposite to the case 26.

In this embodiment, the space buffer mechanism 23 is disposed on and around the case 24, so that the space buffer mechanism 23 and the case 24 can relatively act in accordance with the volume variation of the fluid 21 as shown in FIG. 5B. In this case, the space buffer mechanism 23 can be an extension tube, so that the length thereof can be increased or decreased to buffer the volume variation of the fluid 21.

In addition, the space buffer mechanism 23 may be disposed around the periphery of the case 24 or the case 26.

In the present embodiment, the case 26 is plate-shaped and the case 24 is container-shaped. The electronic element is disposed on the bottom the container, and the opening of the container faces toward the case 26 and is connected with the space buffer mechanism 23. In another embodiment, the cases 24 and 26 can both be plate-shaped.

In addition, at least one part of the case 24 and/or the case 26 is an optical modulation element such as, for example but not limited to, a light-scattering body, a light-condensing body, a wavelength-conversion body, a light-reflection body, or a fluorescent tape, for adjusting the input and output light. Alternatively, the case 24 and/or the case 26 is configured with an optical modulation element such as, for example but not limited to, a light-scattering body, a light-condensing body, a wavelength-conversion body, a light-reflection body, or a fluorescent tape, for adjusting the input and output light.

For example, if the electronic element 22 is an LED and a part of the case 24 is a light-scattering body, the case 24 can cooperate with the fluid 21 to adjust the output angle of the light of the electronic element 22 passing through the case 24. In this case, the case 26 can be a light-reflection body for reflecting the light of the electronic element 22 back to the case 24. Alternatively, if the electronic element 22 is a solar cell and a part of the case 24 is a light-condensing body, the case 24 can cooperate with the fluid 21 to focus the input light on the electronic element 22.

In addition, the above-mentioned design can be modified to dispose a light-scattering body, a light-condensing body, a wavelength-conversion body, a light-reflection body, or a fluorescent tape on the case 24. These optical members can be disposed inside or outside the case 24.

To achieve better heat-dissipation effect, the case 24 may further be disposed with a heat-dissipation body, or at least one part of the case 24 is a heat-dissipation body.

The electronic package device 2 may be combined with other devices. For example, the case 26 can be installed or fixed on an external product or the ground. In this case, the space buffer mechanism 23 and the case 24 are not limited by the external product, so that they can still have relative actions.

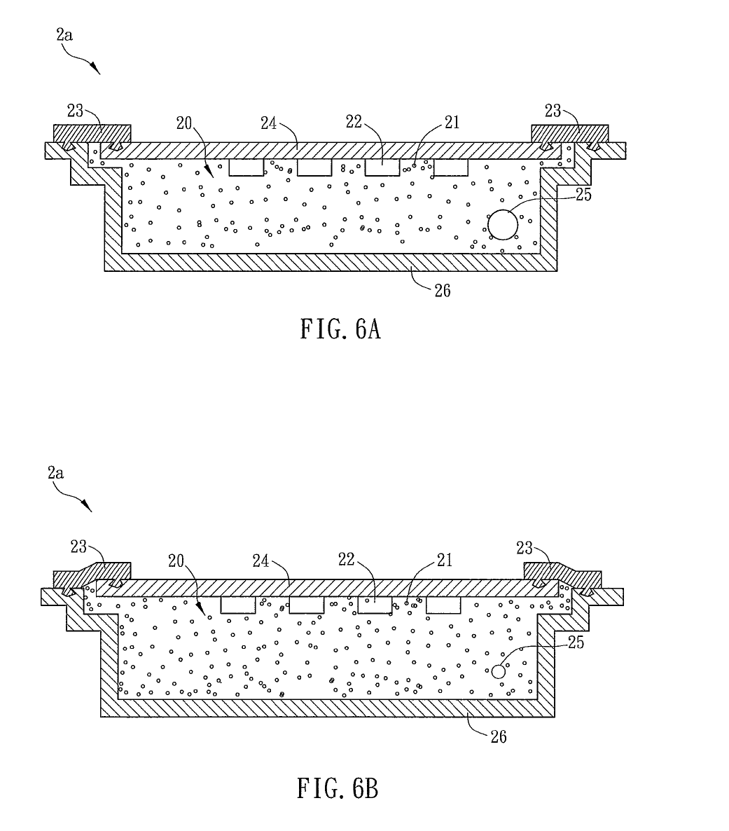

Referring to FIGS. 6A and 6B, an electronic package device 2a is different from that of FIG. 5A in that the cases 24 and 26 are combined with the space buffer mechanism 23 to form the accommodation space 20, and the case 26 has an opening, which is substantially match with the case 24. In this case, the shape of the opening is roughly the same as that of the case 24, and the area of the opening is slightly larger than that of the case 24.

The combination of the space buffer mechanism 23 and the cases 24 and 26 will be described hereinafter. Firstly, the adhesive is disposed on the cases 24 and 26, respectively. Next, the space buffer mechanism 23 is disposed on the cases 24 and 26 corresponding to the adhesive, so that the space buffer mechanism 23 can be combined with the cases 24 and 26. This combination method is simple, and the alignment process is easier because the adhesive is disposed on the same surface of the case 24 and 26. After that, the fluid 21 is injected into the accommodation space 20 so as to prevent the bad influence to the adhesive.

Most part of the accommodation space 20 is used to accommodate the fluid 21 and the electronic element 22, and the other part thereof is used to accommodate the space buffer mechanism 25. In addition, the space buffer mechanism 25 can be removed, so that the whole accommodation space 20 can all used to accommodate the fluid 21 and the electronic element 22.

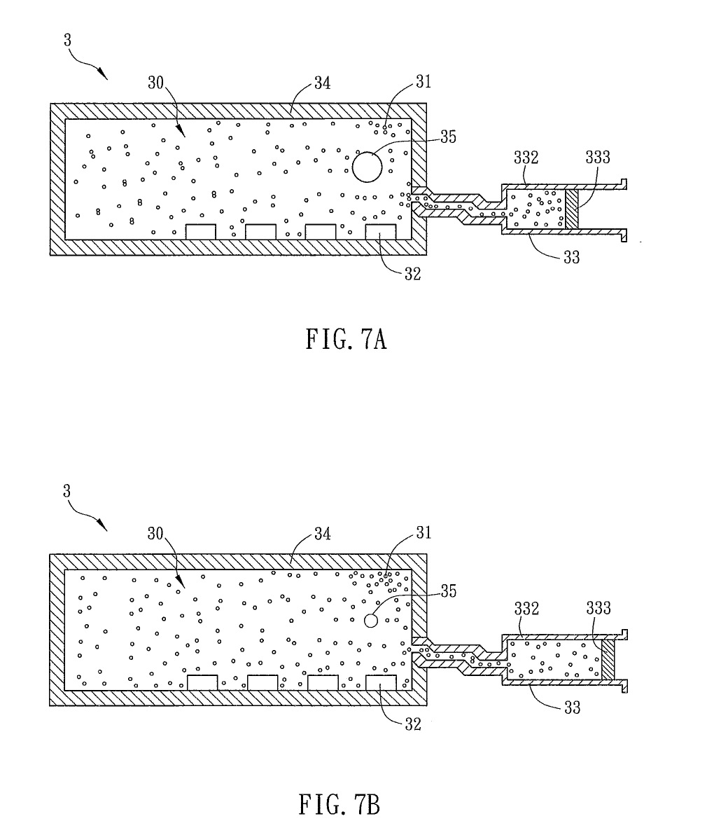

Referring to FIG. 7A, an electronic package device 3 is different from that of FIG. 5A in that the case 34 is combined with the space buffer mechanism 33 to form the accommodation space 30, and the space buffer mechanism 33 is located outside the case 34 and connected with it. In this case, most part of the accommodation space 30 is used to accommodate the fluid 31 and the electronic element 32, and the other part thereof is used to accommodate the space buffer mechanism 35. In addition, the space buffer mechanism 35 can be removed, so that the whole accommodation space 30 can all used to accommodate the fluid 31 and the electronic element 32.

In this embodiment, the space buffer mechanism 33 has a channel 332 and a sliding partition member 333, which is slidingly disposed in the channel 332. The channel 332 is connected with an opening of the case 34, so that the fluid 31 can flow between the space buffer mechanism 33 and the case 34.

When the fluid 31 expends as shown in FIG. 7B, the sliding partition member 333 of the space buffer mechanism 33 moves toward the external space along the channel 332; otherwise, when the fluid 31 constricts, the pressure of the external space is larger, so that the sliding partition member 333 of the space buffer mechanism 33 moves toward the fluid 31 along the channel 332.

In addition, the space buffer mechanism 33 may have a sealed buffer space as the space buffer mechanism 15 of FIG. 2A. In this case, the opening of the space buffer mechanism 33 is sealed, so that the side of the sliding partition member 333 away from the fluid 31 can be used as a buffer space. When the fluid 31 expends, the sliding partition member 333 of the space buffer mechanism 33 moves toward the buffer space along the channel 332. Otherwise, when the fluid 31 constricts, the pressure of the buffer space is larger, so that the sliding partition member 333 of the space buffer mechanism 33 moves toward the fluid 31 along the channel 332.

Because the structures, functions, connections and manufacturing manners of the elements shown in FIGS. 5A to 7B, such as the case, fluid, electronic element, and space buffer mechanism, are the same as or similar to those described in the previous embodiments, the detailed descriptions thereof will be omitted.

In summary, the electronic package device of the present invention has a space buffer mechanism for providing displacement or deformation to buffer a volume variation of the fluid accommodation space. Thus, the electronic package device can be prevented from being damaged by the internal expansion or constriction thereof. In addition, the fluid disposed inside the electronic package device can facilitate the heat dissipation of the electronic element, so that the electronic package device can have better heat-dissipation efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electronic package device having a substantially sealed accommodation space, comprising:
a fluid located in the accommodation space;
an electronic element disposed in the accommodation space, wherein at least a part of the electronic element contacts with the fluid; and
a first space buffer mechanism at least partially contacting with the fluid and providing displacement or deformation to buffer a volume variation of the fluid.

2. The electronic package device according to claim 1, further comprising:
a case containing the accommodation space.

3. The electronic package device according to claim 2, wherein the first space buffer mechanism is disposed inside or outside the case.

4. The electronic package device according to claim 1, further comprising:
at least one case combining with the first space buffer mechanism to form the accommodation space.

5. The electronic package device according to claim 4, wherein electronic package device comprises a plurality of the cases, and two ends of the first space buffer mechanism are connected with the cases to form the accommodation space.

6. The electronic package device according to claim 5, wherein one of the cases has an opening substantially matching with the size and shape of another one of the cases.

7. The electronic package device according to claim 4, further comprising:
a second space buffer mechanism disposed in the accommodation space, wherein a buffer space is formed in the second space buffer mechanism.

8. The electronic package device according to claim 2, wherein at least a part of the case is a circuit board.

9. The electronic package device according to claim 4, wherein at least a part of the case is a circuit board.

10. The electronic package device according to claim 2, wherein the case and the first space buffer mechanism are connected by adhering or embedding.

11. The electronic package device according to claim 4, wherein the case and the first space buffer mechanism are connected by adhering or embedding.

12. The electronic package device according to claim 2, wherein the case has a first portion and a second portion connected with each other, and the first space buffer mechanism is connected with the first portion and the second portion.

13. The electronic package device according to claim 4, wherein the case has a first portion and a second portion connected with each other, and the first space buffer mechanism is connected with the first portion and the second portion.

14. The electronic package device according to claim 4, wherein the first space buffer mechanism is disposed outside the case.

15. The electronic package device according to claim 1, wherein the first space buffer mechanism comprises:
a channel; and
a sliding partition member slidingly disposed in the channel.

16. The electronic package device according to claim 1, wherein the first space buffer mechanism has a buffer space.

17. The electronic package device according to claim 1, wherein the first space buffer mechanism comprises an elastic member or a sliding member.

18. The electronic package device according to claim 1, wherein the first space buffer mechanism comprises a silica gel film, a balloon or a piston.

19. The electronic package device according to claim 1, wherein the fluid is doped with a fluorescent transformation material.

20. An electronic package device, comprising:
a case;
a space buffer mechanism forming a fluid accommodation space with the case and providing displacement or deformation corresponding to a volume variation of the fluid accommodation space;
a fluid located in the fluid accommodation space; and
an electronic element disposed in the fluid accommodation space, wherein at least a part of the electronic element contacts with the fluid.
